(19) United States
(12) Patent Application Publication
(10) Pub. No.: US 2023/0402679 A1
(43) Pub. Date: Dec. 14, 2023

(54) FLUID DISTRIBUTION SYSTEM, BATTERY MODULE ARRANGEMENT AND METHOD FOR CONNECTING BATTERY MODULES IN A FLUIDICALLY CONDUCTING MANNER IN A BATTERY MODULE ARRANGEMENT

(71) Applicant: Witzenmann GmbH, Pforzheim (DE)

(72) Inventor: Alexander Leippi, Pforzheim (DE)

(73) Assignee: Witzenmann GmbH, Pforzheim (DE)

(21) Appl. No.: 18/316,603

(22) Filed: May 12, 2023

(30) Foreign Application Priority Data
Jun. 13, 2022 (DE) 102022114847.5

(51) Int. Cl. H01M 10/6556

(52) U.S. Cl. CPC H01M 10/6556

(57) ABSTRACT

A fluid distribution system for a battery module arrangement including battery modules, each having first and second fluid connectors. The fluid distribution system includes: a first main line element from which there branches off at least one first branch line portion; a second main line element from which there branches off at least one second branch line portion; a first connection element detachably connected to the branch line portion of the first main line element; a second connection element detachably connected to the branch line portion of the second main line element; the first connection element has a first curvature to match a routing direction of the first branch line portion to a routing direction of the first fluid connector; and the second connection element has a second curvature to match a routing direction of the second branch line portion to a routing direction of the second fluid connector.

### CROSS-REFERENCE TO RELATED APPLICATIONS

This application claims priority to German Patent Application No. 10 2022 114 847.5, filed Jun. 13, 2022, which is incorporated herein by reference as if fully set forth.

### TECHNICAL FIELD

The invention relates to a fluid distribution system for a battery module arrangement in which the battery modules each have at least one first fluid connector and each have at least one second fluid connector.

In addition, the invention relates to a battery module arrangement comprising a number of battery modules of which the fluid connectors are connected to a fluid line system according to the invention.

Finally, the invention also relates to a method for connecting battery modules in a fluidically conducting manner in a battery module arrangement according to the invention.

### BACKGROUND

In the context of electromobility, which is becoming more and more widespread, it is necessary to regulate the temperature of the battery modules used for drive purposes, in particular to cool them, during operation. For this purpose, the battery modules normally have a first fluid connector and a second fluid connector, which are designed to introduce a temperature control fluid (cooling fluid) into the battery module and then to discharge it in order to control the temperature of the battery module, or cool the battery module, by means of the temperature control fluid.

For this purpose, the battery modules must be connected to a suitable fluid distribution system so as to enable the temperature control fluid to be delivered and then removed.

Generally, known fluid distribution systems of this type have a complicated structure, use a great multiplicity of different individual parts and are complex and correspondingly costly to produce. For this reason, the assembling of such fluid distribution systems is currently difficult, and servicing, in particular involving module replacement (exchanging of one or more battery modules) is possible only to a limited extent.

In particular, known fluid distribution systems have the problem that the so-called main distribution line or main pipe is composed of horizontally connected rigid individual parts, such that the entire line system has to be disassembled when a module is being replaced. The installation of a busbar (for electrical supply and communication), which is also normally present, thus of necessity accompanies the line installation, thereby making it even more difficult to manipulate.

### SUMMARY

The invention is based on the object of providing a fluid distribution system, a battery module arrangement and a method, each of the types mentioned above, that is of a simplified designed as compared with the known prior art and is therefore characterized by simplified manipulability and lower production and servicing costs.

The object is achieved according to the invention by a fluid distribution system, by a battery module arrangement, and by a method, each having one or more of the features disclosed herein.

Advantageous developments are defined below and in the claims.

A fluid distribution system according to the invention for a battery module arrangement in which the battery modules each have at least one first fluid connector and each have at least one second fluid connector, comprising:
a first main line element from which there branches off, preferably at right angles, at least one first branch line portion;
a second main line element from which there branches off, preferably at right angles, at least one second branch line portion;
a first connection element detachably connected or connectable to the branch line portion of the first main line element;
a second connection element detachably connected or connectable to the branch line portion of the second main line element;
which first connection element has a first curvature in order to match a routing direction of the first branch line portion to a routing direction of the first fluid connector;
which second connection element has a second curvature in order to match a routing direction of the second branch line portion to a routing direction of the second fluid connector.

A battery module arrangement according to the invention comprising a number of battery modules is characterized in that the fluid connectors of the battery modules are connected to a fluid line system according to the invention, wherein preferably a respective first fluid connector is connected to the first main line element and a respective second fluid connector is connected to the second main line element.

A method according to the invention for connecting battery modules in a fluidically conducting manner in a battery module arrangement according to the invention is characterized in that:
a) the battery modules are first arranged in a receiving structure provided therefor and are preferably electrically connected to each other; then
b) the fluid connectors of the battery modules are connected to the respective connection elements; then
c) the main line elements are connected to the connection elements via their branch line portions; and then
d) the main line elements are connected to each other, preferably by means of flexible line elements, preferably by means of (ring) corrugated hoses.

In this way, the invention creates a modular solution for fluidic interfacing of the battery modules, accompanied by the possibility of cost-effective use of common parts and decoupled busbar mounting and demounting.

It is accordingly proposed in the context of the present invention to use a fluid distribution system that can be formed from so-called node elements and from connecting lines that connect the node elements.

The said node elements comprise the main line elements, defined further above, with the respective branch line portions and the connection elements that are connected, or connectable, thereto.

The node elements represent the majority of the complexity of the system in that they allow two-way fluid distribution to and from the battery modules, and are themselves preferably realized as common parts, or formed from a number of common parts.

The node elements are preferably mountable by translation and preferably have flexible elements, or portions, for compensating tolerances between the individual fluid transfer points.

The aforementioned connection lines, which are preferably flexible line elements that serve to connect the main line elements of the node elements (in pairs) to each other, are preferably of a modular structure and are provided, at their ends, with couplings that allow fluid-tight connection to the node elements (in particular to the main line elements there) and are preferably designed to be detachable and secured, or capable of being secured.

For particularly simple assembly, these connections are preferably designed in such a way that they can be effected by translation.

A preferred variant of the invention provides for the connection lines to be flexible, at least partially or in portions, in order to compensate assembly tolerances and to allow individual elements to be replaced without it first being necessary to disassemble the entire fluid distribution system. The said flexibility in this case is preferably achieved by a bellows element and most preferably by a metal hose, in particular a corrugated ring hose.

The developments of the invention described below have proven to be particularly advantageous:

In the case of a further development of the fluid distribution system according to the invention, it is provided that the first main line element and/or the second main line element comprise/comprises a flexible line portion, preferably a corrugated portion, most preferably ring-corrugated.

In this way—as already mentioned—assembly tolerances as well as temperature-related changes in length during operation can be compensated.

In another development of the fluid distribution system according to the invention, it is provided that the first main line element and/or the second main line element have/has, at their/its ends, connector structures, preferably different, most preferably mutually complementary connector structures, for detachable connecting to, respectively, a further main line element.

This supports the achievement of the intended modular structure of the fluid distribution system.

In yet another development of the fluid distribution system according to the invention, it is provided that the first main line element and the second main line element, together with the respective branch line portion, are made of a metal, preferably steel, most preferably high-grade steel.

Such a choice of material has proven in practice to be particularly favorable and resistant, and makes it possible to achieve a thin-walled structure with low weight.

An extremely advantageous development of the fluid distribution system according to the invention provides that the first connection element and the second connection element are made of a plastic, preferably an injection-moldable plastic.

Such a choice of material makes it possible, in particular, to produce more complex geometries that may be required to create a connection to the battery modules.

Another advantageous development of the fluid distribution system according to the invention provides that the first main line element has at least two first branch line portions, and the second main line element has at least two second branch line portions.

Such a design of the main line elements, or the node elements based thereon, makes it possible to connect two battery modules, which may preferably be closely adjacent and most preferably opposite each other. The branch line portions of one main line element in this case may serve to deliver temperature control fluid to the (two) battery modules, while the branch line portions of the other main line element are designed to remove the temperature control fluid from the (two) battery modules. One main line element thus serves to deliver the temperature control fluid as a whole, while the other main line element is thus designed overall to remove the temperature control fluid.

A particularly simple structure of the fluid distribution system according to the invention is obtained if, in the case of a corresponding development, the two first branch line portions and/or the two second branch line portions are of the same length and/or are parallel to each other.

Moreover, in this way it is generally possible to use the respective main line element without the need to pay further attention to its orientation during assembly, which simplifies the assembly process.

Yet another development of the fluid distribution system according to the invention provides that the two first branch line portions are of a different length than the two second branch line portions.

Accordingly, in the case of this development, the two main line elements are not completely identical, but differ in respect of the length of their branch line portions, which, however, are preferably each of the same length for a given main line element.

Thus, with the use of two different main line elements, as outlined above, it is possible, for example, for temperature control fluid to be delivered to the battery modules and for temperature control fluid to be removed from the battery modules at different planes or height levels.

In order to provide for the required tolerance compensation here as well, it has proven advantageous if, in the case of a corresponding development of the fluid distribution system according to the invention, a flexible line portion of the respective main line element is arranged between a respective branch of the two first branch line portions and/or the two second branch line portions, in which case the flexible line portion may be realized, for example, as a (ring) corrugated hose portion.

A highly preferred development of the fluid distribution system according to the invention is that each of the first branch line portions is detachably connected or connectable to a respective first connection element, and that each of the second branch line portions is detachably connected or connectable to a respective second connection element.

The said first and second connection elements respectively provide the fluid connection to the battery modules. If the corresponding connections are designed so as to be detachable, this facilitates assembly and disassembly.

Proven in practice to be particularly advantageous is a design of the fluid distribution system according to the invention in which the one first connection element is realized and designed for connecting to the first fluid connector of a first battery module, and the other first connection element is realized and designed for connecting to the first fluid connector of a second battery module; and in which the one second connection element is realized and designed for connecting to the second fluid connector of the first battery module, and the other second connection element is realized and designed for connecting to the second fluid connector of the second battery module.

In this way, the one main line element with the connection elements connected to it serves exclusively for connecting to one type of fluid connector (delivery or removal of temperature control fluid) of the battery modules, while the other main line element with the connection elements connected to it is designed exclusively for connecting to another type of fluid connector. This, likewise, makes it easier to achieve the modular structure of the fluid distribution system.

It has already been indicated that, advantageously, the interfacing to the battery modules is effected on different planes or height levels. A corresponding development of the fluid distribution system according to the invention provides that the one first connection element and the other first connection element each have, at their one end, a connector structure for a battery module, which connector structures are arranged at the same first height level; and that the one second connection element and the other second connection element each have, at their one end, a connector structure for a battery module, which connector structures are arranged at the same second height level; wherein preferably the first height level and the second height level are different.

The aforementioned use of different height levels makes it possible to achieve improved utilization of the scant installation space that is generally available, in particular in the automotive sector, as well as adaptation to a predefined position of the fluid connectors for the battery modules used.

A particularly advantageous further design of the fluid distribution system according to the invention also provides that the one first connection element and the other first connection element each have, at their other end, a connector structure for a branch line portion, which connector structures are arranged at the same third height level; and that the one second connection element and the other second connection element each have, at their other end, a connector structure for a branch line portion, which connector structures are arranged at the same fourth height level; wherein preferably the third height level and the fourth level are different.

This allows adaptation to a particular length of the connection line portions of a respective main line element, as has already been discussed above.

To further improve the ease of assembly of the proposed arrangement, yet another development of the fluid distribution system according to the invention provides that the one first connection element and the one second connection element, which are preferably designed for connecting to one same battery module, are connected or connectable to each other to form a jointly manipulable unit; and/or that the other first connection element and the other second connection element, which are preferably likewise designed for connecting to one same battery module, are connected or connectable to each other to form a jointly manipulatable unit.

For example, the said connection may be effected via an (injection-molded) bridge, between the said connection elements, that maybe realized directly during production or created subsequently (by means of a separate connection part).

Proven in practice to be particularly advantageous is a development of the fluid distribution system according to the invention in which one of the two first connection elements and one of the two second connection elements are realized as identical parts; and/or in which the other of the two first connection elements and the other of the two second connection elements are realized as identical parts.

The use of a smaller number of different components simplifies stock-keeping and can thus contribute to a further reduction in costs.

It has already been indicated that, as part of an advantageous development of the fluid distribution system according to the invention, it may furthermore also be provided that there is at least one flexible line element, preferably a corrugated hose, that is designed and realized for detachably connecting second first or second main line elements in order to connect the said main line elements, or the respective node elements, to each other to form a more complex fluid distribution system that connects a plurality of battery modules to each other in a fluidically conducting manner.

Such a design makes it possible, not only to compensate tolerances, but also subsequently to install and remove individual battery modules without disassembling the entire fluid distribution system.

Moreover, it is not necessary for all battery modules to be at the same height level or in a perfectly flush arrangement, because corresponding compensation can be easily achieved by means of the flexible line elements.

Nevertheless, a preferred development of the battery module arrangement according to the invention provides that it comprises a plurality of battery modules that are arranged opposite each other as precisely as possible in pairs, wherein the fluid connectors of the battery modules respectively face each other, and wherein a pair of opposite battery modules form the first battery module, mentioned further above, and the second battery module, likewise mentioned further above.

Yet another development of the battery module arrangement according to the invention provides that the battery modules are arranged in one plane and at least some of the battery modules have different dimensions in a direction parallel to the plane and/or perpendicularly to the plane, wherein an offset between the respective first and second main line elements is compensated by means of flexible line elements, preferably (ring) corrugated hoses.

This creates maximum flexibility in arranging the battery modules spatially within the battery module arrangement.

The assembling of the fluid distribution system according to the invention, or the creation of the battery module arrangement according to the invention, is greatly simplified if, in development of the method according to the invention, the battery modules are arranged in a configuration in one plane, as described in detail further above; and the connection elements, in step b), and/or the main line elements, in step c), are introduced, perpendicularly to the plane, into a region between the mutually opposite battery modules.

### BRIEF DESCRIPTION OF THE DRAWINGS

Further advantages and features of the invention are apparent from the following description of exemplary embodiments based on the drawing.

FIG. 1 shows, in schematic form, a battery module arrangement according to the invention with a fluid distribution system according to the invention;

FIG. 2 shows, as an example, a main line element, such as may be used in a fluid distribution system according to the invention;

FIG. 3 shows, as an example, two connection elements for a fluid distribution system according to the invention;

FIG. 4 shows a so-called node element as a constituent part of a fluid distribution system according to the invention;

FIG. 5 shows the node element from FIG. 4, in a somewhat different view;

FIG. 6 shows another node element as a constituent part of a fluid distribution system according to the invention; and

FIGS. 7 and 8 show the use of flexible line elements for connecting the node elements according to FIGS. 4 to 6.

### DETAILED DESCRIPTION

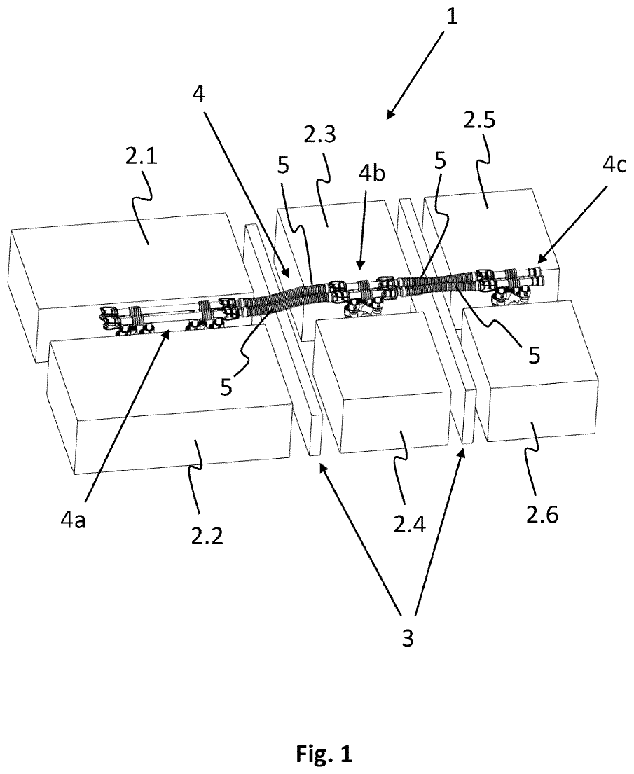

FIG. 1 shows, in schematic form, a battery module arrangement according to the invention with a fluid distribution system according to the invention.

The battery module arrangement is denoted as a whole by the reference designation 1, and in this case comprises (without any restriction in respect of the number) six battery modules, which are denoted by the reference designations 2.1 to 2.6. The battery modules 2.1-2.6 are arranged in a receiving structure suitable for this purpose, which in FIG. 1 is represented only in a very simplified manner, having the reference designation 3.

The battery modules 2.1 and 2.2 have dimensions in height and width that differ from the other battery modules 2.3 to 2.6.

The battery modules 2.1 and 2.2 each have two first and two second fluid connectors, while the other battery modules each have only one first and one second fluid connector. This cannot be seen in detail in FIG. 1 due to the representation chosen.

For example, and without limitation, the first fluid connectors serve to introduce a temperature control fluid into the respective battery module 2.1-2.6, while the second fluid connectors are designed to discharge the temperature control fluid from the respective battery module 2.1-2.6.

The fluid distribution system according to the invention is denoted as a whole by the reference designation 4. According to FIG. 1, it comprises three so-called node elements 4a to 4c, the node element 4a being realized differently from the node elements 4b and 4c.

The node elements 4a-4c are connected in a fluidically conducting manner to the fluid connectors of the battery modules 2.1-2.6. With respect to each other, the node elements 4a and 4b, and 4b and 4c, are connected to each other in a fluidically conducting manner via flexible line elements in the form of (ring) corrugated hoses 5, by which, in particular, height differences between the battery modules, for example between the battery modules 2.1 and 2.2 on the one hand and the battery modules 2.3 and 2.4 on the other hand, can be compensated. In addition, it is possible for the battery modules 2.1 to 2.6 first be equipped with the associated node elements 4a-4c and only then for the node elements 4a-4c to be connected each other in the manner shown. Furthermore, the use of flexible line elements 5 allows the subsequent replacement of individual battery modules 2.1 to 2.6 without disassembly of the entire fluid distribution system 4.

The individual constituent parts of the node elements 4a to 4c shown in FIG. 1 will now be described in more detail. As already described in detail in the introductory part, the node elements comprise a plurality of constituent parts, namely first and second main line elements, first and second branch line portions branching off from the said main line elements, and first and second connection elements, respectively, which are connected or connectable to the respective connection line portion of the respective main line element.

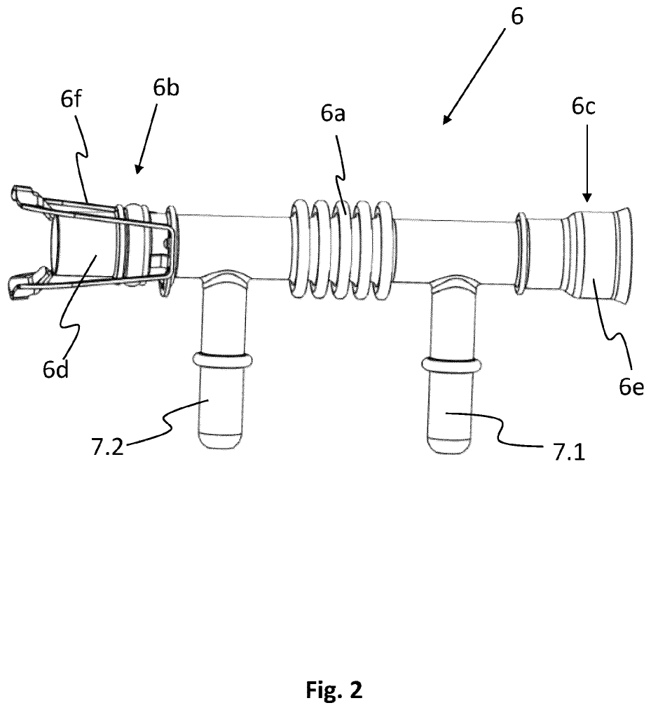

FIG. 2, firstly, now shows a main line element 6 with two connection line portions 7.1, 7.2 branching off from it at right angles, each of which accordingly projects from the main line element 6 at a right angle. The main line element 6 shown may in principle be a first or a second main line element, because in the case of exemplary embodiment shown they differ only in respect of a length of the connection line portions 7.1, 7.2.

Between the branch-off points for the connection line portions 7.1, 7.2, the main line element 6 has a flexible, in this case ring-corrugated portion 6a. At its two free ends 6b, 6c, the main line element 6 has a respective connection structure 6d, 6e for detachable connection to a respective further main line element 6, preferably different, most preferably mutually complementary connection structures 6d, 6e. The connection between the said main line elements 6 may in practice preferably be effected with the interposition of the aforementioned flexible line elements 5, to which reference has already been made (compare FIG. 1).

In FIG. 2, the connector structure at the reference designation 6d is designed as a means of fitting-on a flexible line element, and has an (external) securing device 6f for securing the connection. However, the invention is by no means limited to such (external) securing devices. The connector structure at the reference designation 6e is designed to be complementary thereto and comprises a terminal widened portion into which a flexible line element can be inserted. The associated securing device is then located on the flexible line element (not shown in FIG. 2).

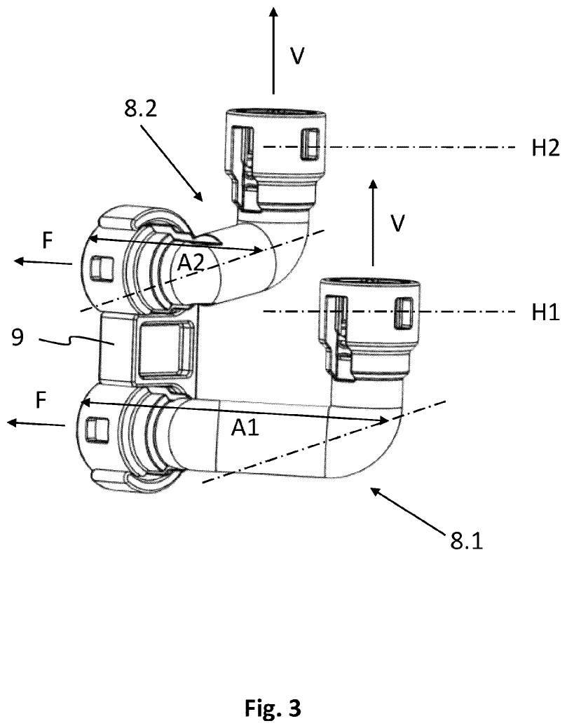

FIG. 3 shows further constituent parts of the said node elements. These are two so-called connection elements 8.1, 8.2, which are each designed and intended to be detachably connected to a connection line portion of a main line element (compare FIG. 2). The connection in this case is effected as indicated by the arrows V. Both connection elements 8.1, 8.2 have a (multiple) curvature in order to match a routing direction of the respective connection line portion to a routing direction of the respective fluid connector of a battery module (not shown in FIG. 3). Connection to the said fluid connectors is effected in this case as indicated by the arrows F, likewise preferably detachably.

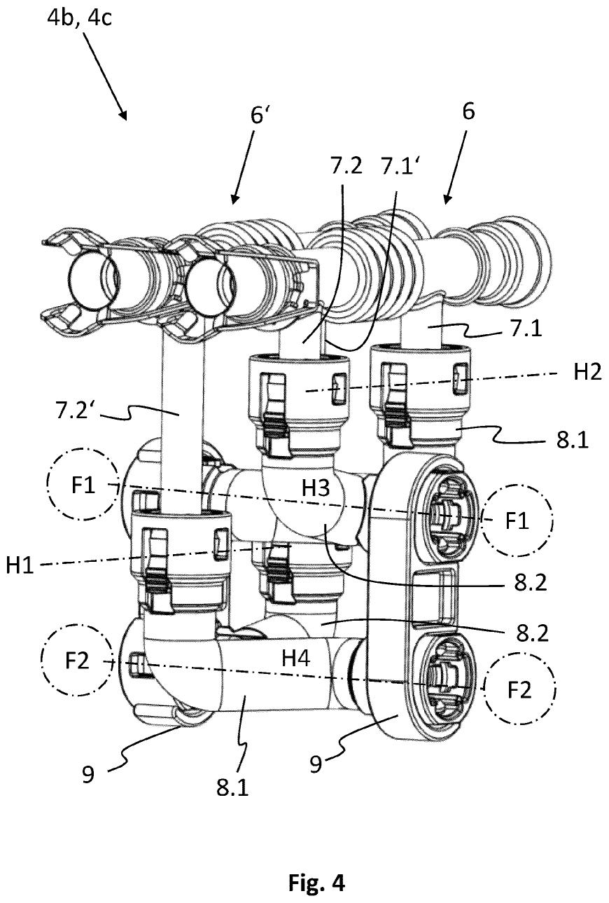

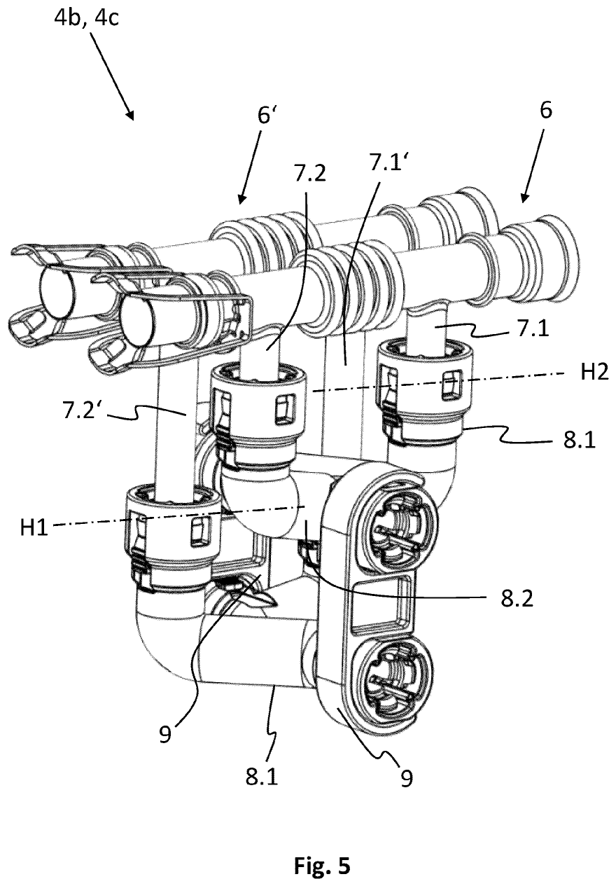

As can also be seen in FIG. 3, the connector ends for connection to the said connection line portions are at different height levels H1, H2. In addition, the said connector ends are also at different lateral distances A1, A2 with respect to the respectively other connector end for connecting to the said fluid connectors. If the design shown in FIG. 3 is used together with a slightly modified design, in which modified design the two connection elements 8.1, 8.2 are transposed, a configuration can be achieved in which the same fluid connectors of different battery modules are each located at the same height levels and at the same lateral distances with respect to the respective connector ends for connecting to the said connection line portions. This will be seen more clearly below with reference to FIGS. 4 and 5.

According to FIG. 3, the two connection elements 8.1, 8.2 are detachably connected to each other via a separate connection part 9, and thus, advantageously for manipulation purposes, constitute one structural unit.

FIGS. 4 and 5 show a complete node element 4b, 4c (compare FIG. 1), which is composed of two main line elements 6, 6′ (which in the context of the present invention are also referred to as the first main line element and the second main line element, respectively) analogous to FIG. 2, and four connection elements 8.1, 8.2 together with the associated connection parts 9 as shown in FIG. 3. The two main line elements 6, 6′ differ in respect of the length of their respective connection line portions 7.1, 7.2 and 7.1′, 7.2′; in this case, the main line element 6 shown in FIG. 4 and FIG. 5 corresponds exactly to the main line element 6 from FIG. 2 (with relatively short connection line portions 7.1, 7.2), whereas the other main line element 6′ has longer connection line portions 7.1′, 7.2′. The connection line portions 7.1, 7.2 that extend from the first main line element 6 are in this case also referred to as first connection line portions, while the connection line portions 7.1′, 7.2′ that extend from the second main line element 6′ are also referred to as second connection line portions.

The main line elements 6, 6′ are arranged parallel to each other—in particular with regard to the extent of the respective connection line portions 7.1, 7.2 or 7.1′, 7.2′. The connection elements 8.1, 8.2 are each combined to form common manipulable component or arrangement as shown in FIG. 3, the connection elements 8.1, 8.2 being transposed between top and bottom in the arrangement located in the rear part of the two figures. In this way, the main line element 6 engages with its two (short) connection line portions 7.1, 7.2 at the same height level H2 and at the same lateral distance (not denoted) in those connection elements 8.1, 8.2 that are designed for connection to the respectively upper fluid connector of two battery modules (not shown) arranged opposite each other. Accordingly, the main line element 6′ engages with its two (long) connection line portions 7.1′, 7.2′ at the same height level H1 and at the same lateral distance (not denoted) in those connection elements 8.1, 8.2 that are designed for connection to the respectively lower fluid connector of two battery modules (not shown) arranged opposite each other.

The connection elements 8.1, 8.2 connected to the (first) main line element 6 are also referred to here as first connection elements, while the connection elements 8.1, 8.2 connected to the (second) main line element 6′ are also referred to here as second connection elements. The two first connection elements are therefore realized differently, and the two second connection elements are also of a different design.

The one first connection element 8.1 and the other first connection element 8.2 each have at their one end a connection structure for a battery module, or for a corresponding fluid connector, which connector structures are arranged at the same (first) height level H3. The one second connection element 8.1 and the other second connection element 8.2 also each have at their one end a connector structure for a battery module or for a corresponding fluid connector, which connector structures are arranged at the same (second) height level H4, the first height level H3 and the second height level H4 being different.

Thus, for example, if the two upper fluid connectors are designed to deliver temperature control fluid to the battery modules, they are both connected to the main line element 6 in this way, whereas the two lower fluid connectors (for removing temperature control fluid) are connected to the main line element 6′.

The said fluid connectors are indicated only in schematic form in FIG. 4. The reference designation F1 in this case denotes the first, upper fluid connector having the height level H3, while the reference designation F2 denotes the second, lower fluid connector (having the height level H4).

The detachable connections mentioned in the region of the connection elements 8.1, 8.2 are preferably plug-in/latching connections, as represented, which act in combination with corresponding projections on the connection line portions 7.1, 7.2 or 7.1′, 7.2′.

In this way, in terms of method, the connection elements 8.1, 8.2 may first be connected in pairs in each case to the two fluid connectors of a respective battery module (each connection element 8.1, 8.2 to a fluid connector). Then the main line elements 6, 6′ are inserted from above with their respective connection line portions 7.1, 7.2 or 7.1′, 7.2′ into the associated connector ends. The main line elements 6, 6′ may then be connected in a fluidically conducting manner to further main line elements of further node elements, in order to create a complete fluid distribution system.

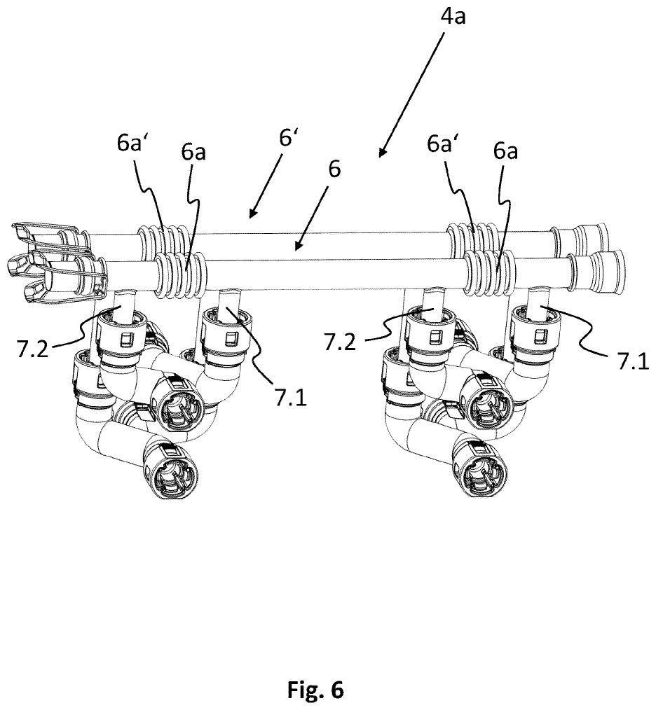

Represented in FIG. 6 is a slightly modified node element that corresponds to the node element 4a from FIG. 1. It differs from the node element according to FIGS. 4 and 5 only in that not only two, but respectively four connection line portions 7.1, 7.2 (only partially denoted for reasons of clarity) branch off from the respective main line element 6, 6′. Arranged between them there is a flexible line portion 6a, 6a′. Accordingly, the number of connection elements 8.1, 8.2 used (not denoted in FIG. 6) is doubled compared to the representation in FIGS. 4 and 5.

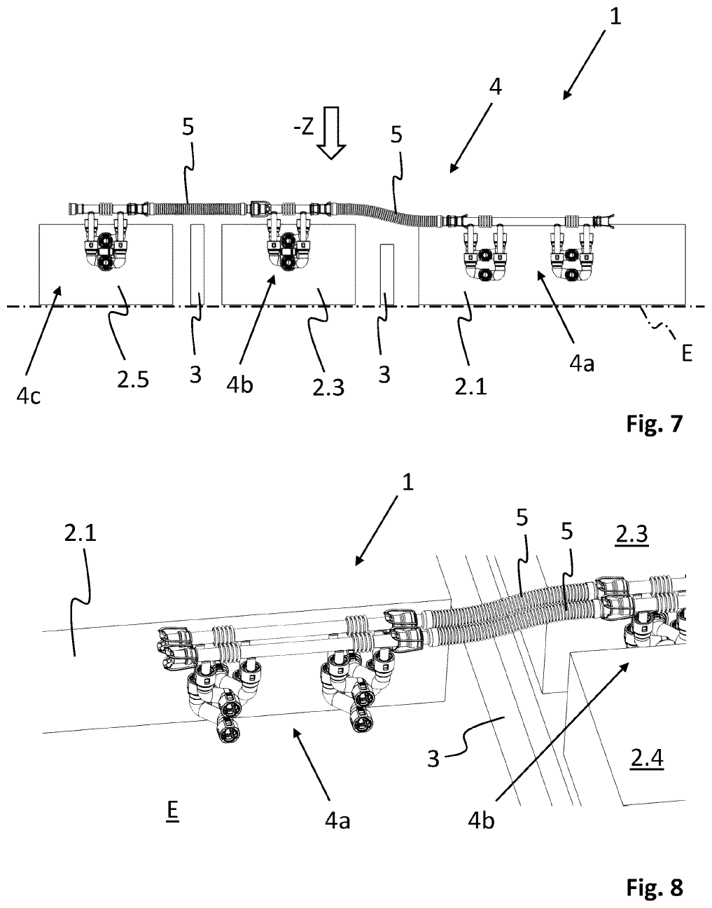

FIG. 7 and FIG. 8, in analogy with the representation in FIG. 1, show how a fluid distribution system 4 according to the invention can be used to compensate height differences between the battery modules used, due to the use of flexible line elements 5. The same applies to lateral offset (not shown).

In addition, in particular the flexible line elements 5 used allow individual battery modules to be replaced without disassembly of the entire fluid distribution system 4.

The battery modules 2.1-2.6 (cf. also FIG. 1) are arranged in a configuration in a common plane E, in particular as shown in FIG. 7. The connection elements and/or the main line elements (cf. FIGS. 3 to 6) are preferably introduced perpendicularly to the plane E, in the direction of the arrow −Z, from above into a region between the mutually opposite battery modules 2.1-2.6. Then, the connection is effected in the transverse direction by means of the flexible line elements 5.

The invention is not limited to use with battery modules having fluid connectors arranged one above the other. If the fluid connectors are adjacent or otherwise offset, a person skilled in the art will specially adapt a (curvature) geometry of the connection elements to further exploit the particular advantages of the invention.

Moreover, it is possible within the scope of the present invention to realize the first and second main line elements as identical parts, i.e. having branch line portions of the same length. In that case, a corresponding adaptation of the connection elements may be required, which might thus be different in each case, as will be readily apparent to a person skilled in the art. In that case, the costs and benefits of such a modification must be assessed accordingly.

1. A fluid distribution system (4) for a battery module arrangement (1) comprising a number of battery modules (2.1-2.6), in which the battery modules (2.1-2.6) each have at least one first fluid connector (F1) and each have at least one second fluid connector (F2), the fluid distribution system (4) comprises:
a first main line element (6) from which there branches off at least one first branch line portion (7.1);
a second main line element (6′) from which there branches off at least one second branch line portion (7.1′);
a first connection element (8.1) detachably connected or connectable to the at least one first branch line portion (7.1) of the first main line element (6);
a second connection element (8.2) detachably connected or connectable to the at least one second branch line portion (7.1′) of the second main line element (6′);
the first connection element (8.1) has a first curvature that matches a routing direction of the first branch line portion (7.1) to a routing direction of the first fluid connector (F1); and
the second connection element (8.2) has a second curvature that matches a routing direction of the second branch line portion (7.1′) to a routing direction of the second fluid connector (F2).

2. The fluid distribution system (4) as claimed in claim 1, wherein at least one of the first main line element (6) or the second main line element (6′) comprise a flexible line portion (6a, 6a′).

3. The fluid distribution system (4) as claimed in claim 1, wherein at least one of the first main line element (6) or the second main line element (6′) has, at ends thereof, connector structures (6d, 6e) configured for detachable connection to, respectively, a further main line element (6, 6′).

4. The fluid distribution system (4) as claimed in claim 1, wherein the first main line element (6) and the second main line element (6′), together with the respective branch line portion (7.1, 7.2, 7.1′, 7.2′), are made of metal.

5. The fluid distribution system (4) as claimed in claim 1, wherein the first connection element (8.1) and the second connection element (8.2) are made of plastic.

6. The fluid distribution system (4) as claimed in claim 1, wherein the first main line element (6) has at least two first branch line portions (7.1, 7.2), and the second main line element (6′) has at least two second branch line portions (7.1′, 7.2′).

7. The fluid distribution system (4) as claimed in claim 6, wherein at least one of the two first branch line portions (7.1, 7.2) or the two second branch line portions (7.1′, 7.2′) are at least one of a) each of a same length or b) parallel to each other.

8. The fluid distribution system (4) as claimed in claim 6, wherein the two first branch line portions (7.1, 7.2) are of a different length than the two second branch line portions (7.1′, 7.2′).

9. The fluid distribution system (4) as claimed in claim 1, further comprising a flexible line portion (6a, 6a′) of the respective main line element (6, 6′) arranged between a respective branch of at least one of the two first branch line portions (7.1, 7.2) or the two second branch line portions (7.1′, 7.2′).

10. The fluid distribution system (4) as claimed in claim 6, wherein each of the first branch line portions (7.1, 7.2) is detachably connected or connectable to a respective first connection element (8.1, 8.2), and each of the second branch line portions (7.1′, 7.2′) is detachably connected or connectable to a respective second connection element (8.1, 8.2).

11. The fluid distribution system (4) as claimed in claim 10, wherein one of the first connection elements (8.1) is configured to connect to the first fluid connector (F1) of a first battery module (2.1-2.6), and another of the first connection elements (8.2) is configured to connect to the first fluid connector (F1) of a second battery module (2.1-2.6); and one of the second connection elements (8.2) is configured to connect to the second fluid connector (F2) of the first battery module (2.1-2.6), and another of the second connection elements (8.1) is configured to connect to the second fluid connector (F2) of the second battery module (2.1-2.6).

12. The fluid distribution system (4) as claimed in claim 11, wherein the one of the first connection elements and (8.1) the other of the first connection elements (8.2) each have, at one end thereof, a connector structure for a battery module (2.1-2.6), said connector structures are arranged at a same first height level (H3); and the one of the second connection elements (8.2) and the other of the second connection elements (8.1) each have, at one end thereof, a second connector structure for the battery module (2.1-2.6), said second connector structures are arranged at a same second height level (H4); and the first height level (H3) and the second height level (H4) are different.

13. The fluid distribution system (4) as claimed in claim 12, wherein the one of the first connection elements (8.1) and the other first connection elements (8.2) each have, at an other end thereof, a branch line connector structure for the first branch line portions (7,1, 7,2), said branch line connector structures are arranged at a same third height level (H2); and the one of the second connection elements (8.2) and the other of the second connection elements (8.1) each have, at an other end thereof, a second branch line connector structure for the second branch line portions (7.1′, 7.2′), said second branch line connector structures are arranged at a same fourth height level (H1); and the third height level (H2) and the fourth level (H1) are different.

14. The fluid distribution system (4) as claimed in any one of claim 10, wherein at least one of a) one of the first connection elements (8.1) and one of the second connection elements (8.2) are connected or connectable to each other to form a jointly manipulatable unit; or b) another of the first connection elements (8.2) and another of the second connections element (8.1) are connected or connectable to each other to form a second jointly manipulatable unit.

15. The fluid distribution system (4) as claimed in claim 10, wherein at least one of a) one of the two first connection elements (8.1, 8.2) and one of the two second connection elements (8.1, 8.2) are formed as identical parts; or b) another of the two first connection elements (8.1, 8.2) and another of the two second connection elements (8.1, 8.2) are formed as identical parts.

16. The fluid distribution system (4) as claimed in claim 1, further comprising at least one flexible line element (5) configured for detachably connecting second ones of the first or second main line elements (6, 6′).

17. A battery module arrangement (1) comprising:
a number of battery modules (2.1-2.6), each having at least one first fluid connector and at least one second fluid connector; and
the fluid distribution system (4) as claimed in claim 1, wherein respective first fluid connectors (F1) are connected to the first main line element (6) and respective second fluid connectors (F2) are connected to the second main line element (6′).

18. A battery module arrangement (1) comprising:
a plurality of battery modules (2.1-2.6) that are arranged opposite each other in pairs, each of the battery modules having at least one first fluid connector and at least one second fluid connector;
the fluid connectors (F1, F2) respectively face each other; and
the fluid distribution system of claim 11, wherein one pair of oppositely arranged battery modules (2.1-2.6) comprise the first battery module (2.1-2.6) and the second battery module (2.1-2.6).

19. The battery module arrangement (1) as claimed in claim 18, wherein the battery modules (2.1-2.6) are arranged in one plane and at least some of the battery modules (2.1-2.6) have different dimensions in a direction that is at least one of parallel to the plane or perpendicular to the plane, and an offset between the respective first and second main line elements (6, 6′) is compensated by flexible line elements (5).

20. A method for connecting battery modules (2.1-2.6) in a fluidically conducting manner in the battery module arrangement (1) according to claim 17, the method comprising:
a) first arranging the battery modules (2.1-2.6) in a receiving structure (3) provided therefor and electrically connecting the battery modules to each other; then
b) connecting the fluid connectors (F1, F2) of the battery modules (2.1-2.6) to the respective first and second connection elements (8.1, 8.2); then
c) connecting the main line elements (6, 6′) to the respective connection elements (8.1, 8.2) via the respective at least one first and at least one second branch line portions (7.1, 7.2, 7.1′, 7.2′); and then
d) connecting the main line elements (6, 6′) to each other.

21. The method as claimed in claim 20, wherein the battery modules (2.1-2.6) are arranged are arranged opposite each other in pairs in one plane, each of the battery modules having at least one first fluid connector and at least one second fluid connector, the fluid connectors (F1, F2) respectively face each other, and at least one of the connection elements (8.1, 8.2), in step b), or the main line elements (6, 6′), in step c), are introduced, perpendicularly to the plane, into a region between the mutually opposite battery modules (2.1-2.6).
